(19) United States
(12) Patent Application Publication
(10) Pub. No.: US 2026/0128814 A1
(43) Pub. Date: May 7, 2026

(54) METHOD AND SYSTEM FOR IMPROVING FORWARD ERROR CORRECTION IN SERIAL CODING DURING DATA TRANSMISSION

(71) Applicant: INOVA SEMICONDUCTORS GMBH, Munich (DE)

(72) Inventors: Fabian KLUGE, Perasdorf (DE); Roland NEUMANN, Bad Toelz (DE)

(73) Assignee: INOVA SEMICONDUCTORS GMBH, Munich (DE)

(21) Appl. No.: 19/425,560

(22) Filed: Dec. 18, 2025

Related U.S. Application Data
(63) Continuation of application No. PCT/EP2024/055981, filed on Mar. 7, 2024.

(30) Foreign Application Priority Data
Jun. 21, 2023 (EP) 23180788.4

(51) Int. Cl. H04L 1/00

(52) U.S. Cl. CPC H04L 1/0042; H04L 1/0071

(57) ABSTRACT

A method for improving the forward error correction in serial coding in a data transmission in a vehicle allowing the physical behavior on a transmission channel to always be deterministically controlled despite a reduction in the resource requirements. Tit errors are minimal and a transmission error can be corrected efficiently. In addition, encoders used are designed with a minimum number of gates and an interleaving is implicit in the proposed method, which is based on the fact that burst errors can be corrected particularly advantageously. This interleaving makes it possible to dispense with conventional buffer memory required for explicit interleaving. In addition, user data together with correcting metadata can be encoded advantageously. It can be ensured that not only the user data is line-coded or line-encoded, but also the correction data. Also provided is a system for implementing the method.

### CROSS REFERENCE TO RELATED APPLICATIONS

This application is a continuation of International Application No.

PCT/EP2024/055981, filed on Mar. 7, 2024, which takes priority from European Application No. 23180788.4, filed on Jun. 21, 2023 the entire contents of each of which are incorporated by reference herein.

### TECHNICAL FIELD

The present invention is directed to a method for improving forward error correction in serial coding in a data transmission in a vehicle and, compared to the prior art, creates, among other things, the advantage that the physical behavior on a transmission channel can always be deterministically controlled despite a reduction in the resource requirement. Thus, according to the proposed method, the bit errors are minimal and a transmission error can be corrected efficiently, i.e. with minimal technical effort. In addition, the encoders used are designed with a minimum number of gates and an interleaving is implicit in the proposed method, which is based on the fact that so-called burst errors can be corrected particularly advantageously. This implicit interleaving makes it possible to dispense with the conventional buffer memory required for explicit interleaving. In addition, the invention ensures that user data together with correcting metadata can be encoded advantageously with regard to transmission. According to the invention, it can be ensured that not only the user data is line-coded or line-encoded, but also the correction data. The present invention is also directed to an analogously designed system arrangement for carrying out the method and to a computer program product with control commands which execute the method.

### BACKGROUND

US 2003/237041 A1 shows a system and a method for transmitting a packet via a data link. The packet may include a stream of data symbols bounded by one or more frame symbols. Damage to the frame symbol that results in valid data symbols may be associated with invalid symbols.

U.S. Pat. No. 7,103,830 B1 shows that two types of encodings are integrated instead of performing each encoding separately. The two encodings can be integrated by interleaving one or more steps of one encoding method (e.g. data encoding) between two or more steps of the other encoding method (e.g. line encoding).

Various versions of the Ethernet protocol are known from the prior art.

Ethernet uses a variety of techniques to detect and correct errors during data transmission. The error correction mechanisms are part of the Ethernet protocol and ensure that the data received is correct and complete. Cyclic Redundancy Check (CRC) is one of the most important error detection techniques in Ethernet. With CRC, a checksum is calculated for the data sent and attached to the packet. At the receiver, the checksum is calculated again and compared with the checksum received. If the checksums do not match, an error is detected and the packet is discarded.

Forward error correction is also known from the state of the art. Forward Error Correction (FEC) is a method of error correction in which additional redundancy information is added to the data. This redundancy enables the receiver to detect and correct errors without having to resend the packet. FEC is often used in high-speed Ethernet connections such as 10 Gigabit Ethernet (10GbE) to ensure data integrity.

Link-level error correction is also known from the state of the art. Ethernet can also perform error correction at the physical level. Techniques such as signal amplification, noise suppression and error correction codes are used here to improve the stability of data transmission. These error correction mechanisms are implemented in the Ethernet transceivers that perform the conversion between digital data and physical signals.

Error correction mechanisms play a crucial role in ensuring reliable data transmission in networks. They help to detect, isolate and correct transmission errors to ensure that data integrity is maintained. Especially in mission-critical environments where large amounts of data are transmitted, error correction mechanisms are essential to maintain the quality of the connection.

In addition, the DisplayPort standard is well known. DisplayPort uses various error detection and correction methods to ensure that the transmitted data is reproduced accurately and without loss. These mechanisms are part of the DisplayPort protocol and contribute to the stability and quality of data transmission. Forward Error Correction (FEC) is an important error correction method for DisplayPort. Additional redundancy information is inserted into the transmitted data. This redundancy enables the receiver to recognize and correct erroneous data bits. In this way, errors that occur during transmission can be effectively corrected without having to resend the data.

Furthermore, it is generally known from the prior art that data transmission via a serial data channel is typically subject to errors. To counter this problem, the state of the art recognizes different encodings, such as line coding. This is also known as line coding.

The state of the art recognizes the problem of faulty data transmission via a serial communication link and provides for the line-coded data to be provided with a forward error correction. The state of the art therefore addresses the problem of error correction by providing line-coded data with a non-line-coded addition, namely forward error correction, which in turn is not line-coded. The problem in the state of the art is therefore that even if line coding is provided, individual metadata is not transmitted in coded form and therefore the advantages of line coding cannot be used for all transmitted data. This in turn represents a source of error. The state of the art sometimes makes do by encoding the forward error correction data separately and then transmitting it. This results in additional work and a new forward error correction would have to be calculated in order to secure the line-coded forward error correction data. This in turn creates additional effort and also creates a non-line-coded forward error correction.

In addition, the state of the art has the problem that the forward error correction is always calculated over entire data words, so that an enormous technical effort is required to maintain and operate an exponentially growing number of gates with regard to an increasing word length. As a result, the state-of-the-art encoders that calculate the forward error correction are extremely expensive to manufacture and are also more prone to errors. In addition, they consume large amounts of energy, which is not desirable in vehicles. Errors relating to an entire word also propagate more than if error corrections were formed using partial words, which in turn leads to increased susceptibility to errors. This is also undesirable in the vehicle, as data transmission is safety-critical, especially in the vehicle. The susceptibility to errors is therefore particularly significant in an automobile or a vehicle in general, as safety-critical functions have to be provided.

Various coding methods and data transmission methods are known from the state of the art, but all of them relate to application scenarios that can only be used to disadvantage in an automobile. The state of the art often assumes that high computing power is available and that there are no high real-time requirements. In addition, the state of the art often assumes that the weight or reliability of the components to be used plays a subordinate role. The state of the art often refers to conventional computer networks, where reliability and low technical complexity are less important.

Based on this state of the art, there is a need to create a method or a system arrangement which enables data to be processed as quickly as possible due to the safety requirements in the automobile and which also requires little technical effort and minimizes the error rate during transmission, as retransmission is not possible if an error is detected. The low technical effort should consist of installing components that are as simple as possible, have a low weight and can also be produced efficiently in large quantities. Known methods and system arrangements from computer network technology cannot typically be used here, as weight savings and real-time running behavior are not decisive for a stand-alone PC or server. Although the heat to be dissipated generally poses a challenge for computer arrangements, energy efficiency in an automobile is of even greater importance, since in electromobility, for example, power consumption even influences the range of the automobile.

Further state of the art relates to the transmission of data in a serial data stream. For example, the state of the art provides for extensive description data to be sent along with the user data, indicating where the user data is located and how it is to be interpreted. In addition, it is known in the state of the art to discard individual data packets if they are not transmitted correctly. It is also known in the state of the art to resend data packets if they do not arrive at a sender on time or in an unexpected format.

In the serial transmission of data, it is necessary to have as many ones and zeros as possible in the serial data stream. This is called disparity. A disparity of zero on average and also over a short period of time is desirable to avoid baseline drift during transmission. The baseline drift (DC voltage fluctuation) of the serial signal leads to bit errors. In extreme cases, transmission is not possible.

A minimum number of 0->1 or 1->0 transitions is required to be able to reliably recover the serial bits in the serial data stream at the receiving end without the need to transmit a clock. This means that the clock for recovering the serial data is generated locally at the receiver from the serial data stream. The so-called run length specifies how many identical bits (ones or zeros) can occur in succession without changing. A short run length is always desirable, as long run lengths no longer allow the clock to be reliably recovered from the serial data stream.

The task of the line code (in this case a block code or line code) is now to generate a symbol with guaranteed disparity and guaranteed run length from any data words with any disparity and infinite run length. This leads to an overhead during transmission. This means that more bits (in the form of symbols) have to be transmitted than occur in the net data word to be transmitted. This means that the required transmission speed (bandwidth) must be greater than the data rate of the data to be transmitted. This in turn means that systems require higher error rates or more effort, power, etc. than would be necessary to transmit the raw data.

It is therefore a task of the present invention to propose a method for improving forward error correction in serial coding during data transmission in a vehicle. The proposed method should be efficient, require little technical effort and be as error robust as possible. Furthermore, it is a task of the present invention to provide an appropriately equipped system arrangement for carrying out the method. Furthermore, it is a task of the present invention to propose a computer program product which provides control commands which implement the method or operate the system arrangement. In addition, a storage medium with control commands is to be proposed.

### SUMMARY

The problem may be solved in accordance with this disclosure.

Accordingly, a method for improving the forward error correction in serial coding in a data transmission in the vehicle is proposed, comprising a provision of user data to be transmitted; a division of the provided user data into a plurality of bit sequences of the same length in each case; reading out a subdivision rule which subdivides a bit sequence into a sequence of segments each of predefined length at a predefined bit position; applying the read-out subdivision rule to all bit sequences of the plurality of bit sequences; iteratively creating a respective partial forward error correction for all segments of the same bit position over all bit sequences; an iterative application of a respective segment encoder over all segments of the same bit position to generate segment routing codes over all segments per bit position and per bit sequence; an application of the respective segment encoder to the respective partial forward error correction which was also applied to the segments with respect to which the respective partial forward error correction was created to generate a respective partial forward error correction routing code per partial forward error correction; and a transmission of all segment routing codes and all partial forward error correction routing codes.

According to embodiments of the invention, the forward error correction is improved in that it is calculated with respect to user data and in that the user data is first segmented for this purpose. A separate forward error correction is then calculated for each segment, so that the forward error correction does not relate to an entire data word, but to different subwords. This keeps the number of gates of the FEC coders to be used low and avoids exponential growth. In addition, an improvement results from the fact that, according to embodiments of the invention, a line coding is carried out via the user data together with the forward error correction, thus overcoming the disadvantage in the prior art that the forward error correction is transmitted in a non-coded form.

Furthermore, it is advantageous that the error correction can work more efficiently, since the error correction only refers to partial words and can therefore recognize in fine granularity where an error has occurred. Conventional error corrections always refer to entire data words and are therefore inefficient or errors can occur in the prior art that cannot be corrected. This is avoided by the segmentation according to embodiments of the invention.

A further improvement is that all transmitted data is line coded and thus the entirety of the data can benefit from the line coding. The transmission link can therefore be deterministically controlled and bit errors are kept to a minimum. In addition, implicit interleaving results from the fact that smaller packets are sent and thus implicit interleaving occurs, as not all of the data words are transmitted. This is achieved by using several forward error correction encoders, each of which refers only to partial words. Thus, the disadvantage in the prior art of having to create an explicit interleaving at great expense, which would also require additional buffer memories, is overcome.

Due to the optimized disparity (line coding) of the bit sequence to be transmitted, it is possible to avoid errors when interpreting on a serial channel. Efficiency therefore also refers to the fact that the bit sequence is particularly error-resistant and can therefore only be reliably transmitted once. Redundant transmission is avoided due to the high detectability, again due to the optimized disparity.

In the serial transmission of data, it is advantageous to keep the number of ones and zeros in the serial data stream as equal as possible. This is generally referred to as disparity. For reliable clock recovery at the receiver, a run length restriction can be imposed on the generated channel sequence. This limits the maximum number of consecutive ones and zeros. Thus, the proposed method can also be described as a method for efficient coding of a bit sequence. The disparity is optimized by cleverly setting partial disparities. This can be used particularly advantageously if the run length of the bit sequence is limited. The restricted disparity and the restricted run length can also relate to the arbitrary bit sequence provided. This means that it does not have to be the efficiently transferable bit sequence. Overall, the arbitrary bit sequence provided can be transmitted efficiently or a bit sequence to be transmitted is generated or created from this bit sequence, which can then be transmitted efficiently.

The proposed method can be used specifically in the vehicle or is specially tailored to the requirements in the vehicle. This is the case because safety-critical functions are offered in the vehicle, which must be protected accordingly. According to embodiments of the invention, this is done in several ways. On the one hand, through forward error correction and via line coding. In addition, the reduced number of gates required is particularly advantageous in electromobility.

According to embodiments of the invention, user data to be transmitted is provided in a preparatory process step. This is typically a bit sequence of a fixed length. This can also be referred to as a data word.

The user data provided is then divided into a number of bit sequences of the same length. In a preferred embodiment, these bit sequences can have a length of 112 bits. While the user data can be a continuous data stream, the bit sequences are always of a certain length and in some way provide a subdivision of the user data. In the following, a bit sequence is also referred to as a data word. Furthermore, it is assumed in the following, especially in the figures, that the bit sequences are arranged one below the other, figuratively speaking. This means that each individual bit sequence extends horizontally and the individual bit sequences are arranged vertically one below the other.

Since the bit sequences are now segmented, a subdivision rule is read out, which divides a bit sequence into a sequence of segments of a predefined length at a predefined position. The individual segments do not have to be the same length; this can vary from segment to segment. However, the subdivision rule stipulates that the individual bit sequences each have the same format, so that, figuratively speaking, the same subdivisions result vertically. For example, a first segment of each bit sequence can have 11 bits. For example, the first four segments can also each have 11 bits, followed by a segment of 7 bits. This can be followed by another segment with 11 bits and then a segment of 6 bits. This data format is maintained for all bit sequences. This means that the segments at the same position can always be of the same length, although the segments can differ vertically, figuratively speaking. The segments per line then form the bit sequence. The bit sequences in their vertical arrangement form the user data in their entirety.

This means that the read-out subdivision rule is applied to all bit sequences of the multiple bit sequences until the entire user data is broken down horizontally into bit sequences and the segments are formed vertically. This means that all bit sequences are subdivided according to the same subdivision rule. The subdivision rule applies to all bit sequences obtained from the user data.

Now an iterative creation of a partial forward error correction for all segments of the same bit position takes place across all bit sequences. Thus, figuratively speaking, a forward error correction is calculated for all vertical segments that are in the same bit position or the same sequence for all segments. This is carried out for all segments so that partial forward error corrections have been created for all bit sequences and therefore for the complete user data. The total of all partial forward error corrections thus creates a total forward error correction, which refers to the complete user data or all bit sequences.

In general, it is also possible that the user data is only divided into one bit sequence or that the user data is already available in its length as one bit sequence. A partial forward error correction is then generated for each segment.

Now an iterative application of a segment encoder is carried out over all segments of the same bit position to generate segment line codes over all segments per bit position and per bit sequence. In other words, line coding is carried out over all vertical segments, figuratively speaking. This is advantageous in that line encoders are provided specifically for predetermined lengths. This ensures that the vertical segments can each be encoded by a single line encoder. The iterative application of the segment encoders therefore ensures that, figuratively speaking, the segments are line-encoded column by column and this is done across all segments until all bit sequences are line-encoded with respect to their segments.

It is particularly advantageous that the partial forward error correction has the same number as the respective segments. This means that the partial forward error correction can be coded using the same line encoder as the corresponding segments.

In each case, the segment encoder that was also used for the segments with respect to which the respective partial forward error correction was created is applied to the respective partial forward error correction to generate one partial forward error correction line code for each partial forward error correction. This means that those segment encoders are used that have line-encoded the respective segments and then also line-encode the respective partial forward error corrections. This means that the segments are line-encoded column by column with the same segment encoder as the partial forward error corrections that relate to the respective column.

All segment line codes and all partial forward error correction line codes are then transmitted.

According to one aspect of the present invention, the subdivision is read out from a hardware architecture. This has the advantage that the subdivision rule can be statically predefined or can also be changed in the data memory. In addition, the subdivision rule can take the corresponding hardware architecture into account. If, for example, different encoders are provided for different bit lengths, the bit sequences can be subdivided in such a way that the corresponding segments correspond to the respective encoders. The segments therefore have exactly the length provided by the respective encoder.

According to a further aspect of the present invention, all bit sequences have the same structure in their data format, have the same segment lengths and/or the same bit positions. This has the advantage that the individual segments can be fed to the respective encoders. For example, each first segment of each bit sequence is fed to the same encoder. Thus, figuratively speaking, the segments can be encoded column by column and there is a specialized encoder for each column.

According to a further aspect of the present invention, the partial forward error correction has correction information which describes a target content of the segment over which the partial forward error correction was created. This has the advantage that the transmitted data can be corrected by means of this correction data, whereby an entire correction is not formed for each bit sequence, but rather individual partial forward error corrections are formed for the individual segments. All partial forward error corrections in their entirety describe all segments of all bit sequences and therefore all user data. The difference to the state of the art here, however, is that a forward error correction is not formed for each bit sequence, but for all segments across all bit sequences. It is thus possible to use the same line encoder for each partial forward error correction that is used for the corresponding segments.

According to a further aspect of the present invention, the partial forward error correction has the same bit length as the segment over which it is generated. This has the advantage that specialized line encoders can be provided and thus maximum efficiency is created in that the corresponding column-wise line encoders are specialized for exactly the bit length that they then also have to encode. Thus, an efficient and technically minimally complex method is created.

According to a further aspect of the present invention, an entirety of the partial forward error corrections describes all user data to be transmitted in a correctable manner. This has the advantage that all user data which are transmitted can be corrected with regard to their errors, but can be based on the individual segments, so that the proposed method is more finely granular than the prior art provides.

According to a further aspect of the present invention, the segment encoders each generate at least part of a line code. This has the advantage that the outputs of the segment encoders can be combined and then provide the line codes to be transmitted.

According to a further aspect of the present invention, the set of segment encoders encodes bit sequences of 112 bits into words of 128 bits. This has the advantage that a particularly efficient line code is created.

According to a further aspect of the present invention, the partial forward error correction line codes are appended to the segment line codes during transmission. This has the advantage that all data to be transmitted is line coded and thus the line is operated deterministically or the advantages of line coding can be utilized for all data and not only for the payload data per se.

According to a further aspect of the present invention, the bit position is specified as an offset or as a bit index in the bit sequence. This has the advantage that different types of addressing can be used and the index is based on a sequence of the respective segments, which can then be advantageously specified using known methods.

According to a further aspect of the present invention, the user data is available as a serial data stream. This has the advantage that theoretically any amount of user data can be transmitted, which is then divided into bit sequences of the same length.

According to a further aspect of the present invention, the method steps are carried out in the described sequence and/or are carried out iteratively. This has the advantage that the coding sequence is reversed. It is provided that the forward error correction is created first and then the line coding is performed. This does not exclude the possibility that individual process steps have to be carried out several times. This may be the case, for example, if several bit sequences are present and these have to be segmented.

According to one aspect of the present invention, a line code segment is generated for each data subword block and/or each data subword block forward error correction. This has the advantage that the forward error correction in particular does not have to be transmitted in uncoded form, but is instead also line-coded. Thus, the advantages of line coding are not only available for the user data but also for the forward error correction.

According to a further aspect of the present invention, a forward error correction for a data block is composed of several partial forward error corrections of the data subword blocks. This has the advantage that not an entire forward error correction is initially generated, but many individual partial forward error corrections, which in their entirety form an overall forward error correction. In this way, the number of gates of the required FEC encoders is kept to a minimum. Nevertheless, it is possible to protect all data by means of a forward error correction and, in addition, to transmit the data together with the forward error correction FEC in line coded form.

According to a further aspect of the present invention, the data structure is read out and a forward error correction sub-encoder is selected depending on the respective bit lengths of the data sub-words. This has the advantage that the FEC encoders are precisely tailored to the segment lengths or the bit lengths of the subwords. In this way, it is possible to minimize the number of gates in such a way that the encoders only have to create encodings for small subwords and not for the entire data words. Consequently, each FEC encoder is precisely tailored to the bit length of the data subword to be encoded.

According to a further aspect of the present invention, the number of gates of the FEC partial encoders is selected as a function of a bit length of the data subwords. This has the advantage that, compared to the prior art, the number of gates required in the FEC coders is reduced and thus an efficient system arrangement or an efficient method is created, which is particularly advantageous in the automobile or in the vehicle. In this way, no gates need to be provided that would not be necessary. This results in a deterministic and minimal number of gates.

According to a further aspect of the present invention, the number of all gates of all encoders is selected in such a way that iterative execution of the method results in a linear increase in the number of gates with respect to increasing data word lengths. This has the advantage that a minimum number of gates is provided, taking into account the data format, or that the data format can be selected in such a way that only a linear increase in the number of gates is necessary. For example, in one embodiment, the maximum bit length can be 10, 11 or 12 bits, which means that the required gates or circuits of the FEC encoder only increase linearly. Since an exponential growth of gates is necessary for larger values, embodiments of the present invention create the technical effect that the power consumption or energy consumption is minimized, which in turn leads to less waste heat. In addition, the proposed method is particularly robust, which is particularly advantageous in automobiles, as safety-critical functions are offered here.

According to a further aspect of the present invention, each data word has 112 bits. This has the advantage that words of 128 bits can be created with line coding, which corresponds to a common format. It has been shown that 112 bits in particular can be encoded robustly 128 bits. This ensures that the transmission is subject to a lossy or error-prone data channel.

According to a further aspect of the present invention, the bit length of the data subword block forward error correction is selected such that it corresponds to the bit length of the data subwords. This has the advantage that both the forward error correction and the data subwords or segments can be encoded using the same encoder, which is the line encoder, i.e. not the FEC encoder. Thus, embodiments of the present invention make the technical contribution that not only a minimum number of gates must be provided, but also the total number of encoders is minimized. Thus, the forward error correction can be line coded with the same encoder as the actual segments of the user data.

According to a further aspect of the present invention, the data subword block forward error correction and the data subword block on the basis of which the data subword block forward error correction is calculated are line-encoded using the same line encoder. This has the advantage that a minimum number of line encodings must be provided. Figuratively speaking, virtually all columns, i.e. all partial word blocks together with the corresponding partial forward error correction, are line-encoded with the same segment encoder in each case.

According to a further aspect of the present invention, the data structure is selected as a function of the bit length of the data words. This has the advantage that the different bit lengths can also be dealt with dynamically at runtime and thus the same data format can be selected for further data words as for a first data word provided. If first data words are available, a corresponding data structure can be used for a further serial data stream and the further data words are structured in such a way that they correspond to the data structures of the data words received first.

According to a further aspect of the present invention, serial line coding is performed after the data subword block forward error correction has been calculated.

This has the advantage that the order as provided in the prior art is reversed and the forward error correction is calculated first, which means that it can also be line coded and does not have to be transmitted unencrypted or uncoded.

According to a further aspect of the present invention, the method steps are performed in a virtualized manner and information about the underlying encoders and/or gates is generated. This has the advantage that the embodiments can be evaluated in a preparatory process step and, in this respect, it can be determined how many gates or how many FEC encoders and/or line encoders are to be provided. In addition, the process as a whole can be simulated. Hardware components can be provided virtually.

The problem is also solved by a system arrangement for improving forward error correction in serial coding in a data transmission in the vehicle, comprising an interface unit set up to provide user data to be transmitted; a splitting unit set up to split the user data provided into a plurality of bit sequences of the same length in each case; a further interface unit set up for reading out a subdivision rule which subdivides a bit sequence into a sequence of segments each of predefined length at a predetermined bit position; a subdivision unit set up for applying the read-out subdivision rule to all bit sequences of the plurality of bit sequences; a correction unit set up for iteratively creating a respective partial forward error correction for all segments of the same bit position over all bit sequences; a coding unit set up for iteratively applying a respective segment coder over all segments of the same bit position to generate segment line codes over all segments per bit position and per bit sequence; a further encoding unit arranged to apply to the respective partial forward error correction the respective segment encoder which was also applied to the segments with respect to which the respective partial forward error correction was created in order to generate a respective partial forward error correction guide code for each partial forward error correction; and a transmission unit arranged to transmit all segment guide codes and all partial forward error correction guide codes.

This disclosure is also directed to a system arrangement or method which receives and then decodes the data and reads out both the forward error correction and the useful data.

The problem is also solved by a computer program product with control instructions which implement the proposed method or operate the proposed device.

It is particularly advantageous that the method can be used to operate the proposed devices and units. Furthermore, the proposed devices and units are suitable for implementing the method according to the invention. Thus, in each case the device implements structural features which are suitable for carrying out the corresponding method. However, the structural features can also be designed as process steps. The proposed method also provides steps for implementing the function of the structural features. In addition, physical components can also be provided virtually or virtualized.

### BRIEF DESCRIPTION OF THE DRAWINGS

Further advantages, features and details of the invention are provided in the following description, in which aspects of the invention are described in detail with reference to the drawings. The features mentioned in the claims and in the description may each be essential to the invention individually or in any combination. Likewise, the above-mentioned features and the features further described herein may be used individually or in any combination. Functionally similar or identical parts or components are sometimes provided with the same reference signs. The terms “left”, “right”, “top” and “bottom” used in the description of the embodiments refer to the drawings in an orientation with a normally legible figure designation or normally legible reference signs. The embodiments shown and described are not to be understood as conclusive, but are exemplary in nature for the purpose of explaining the invention. The detailed description is for the information of the person skilled in the art, therefore known circuits, structures and methods are not shown or explained in detail in the description so as not to make the present description more difficult to understand. The figures show:

FIGS. 1A-C illustrating several examples of a process flow with serial coding and calculation of a forward error correction according to the prior art;

FIG. 2 illustrating an optimized process flow with forward error correction and serial encoding according to an aspect of the present invention;

FIG. 3 illustrating an encoding of user data and a calculation of a forward error correction according to the prior art;

FIG. 4 illustrating a method for improving forward error correction in serial encoding in an in-vehicle data transmission according to the present invention;

FIG. 5 showing a comparison of the prior art coding and the method for improving forward error correction according to an aspect of the present invention;

FIG. 6 showing a diagram illustrating the required number of gates per bit length of forward error corrections;

FIG. 7A showing an encoding of user data into a line code according to an aspect of the present invention;

FIG. 7B showing the proposed system arrangement for improving forward error correction in serial coding in an in-vehicle data transmission according to an aspect of the present invention;

FIG. 8A showing an aspect of the method for improving forward error correction according to an aspect of the present invention on the transmitter side;

FIG. 8B showing a method for improving forward error correction at the receiver side according to an aspect of the present invention; and

FIG. 9 providing a flowchart of a method for improving forward error correction in serial coding in a data transmission according to an aspect of the present invention.

### DETAILED DESCRIPTION

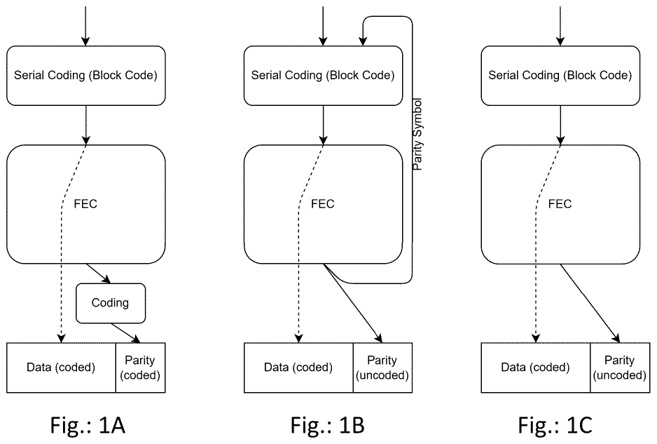

FIGS. 1A-C show three examples of how a forward error correction is carried out according to conventional methods. On the left-hand side, an example is shown which first performs serial coding of the user data and then generates a forward error correction code FEC. The serially encoded data is transmitted and the forward error correction is subsequently encoded and then appended to the encoded user data. Thus, according to this example from the state of the art, the forward error correction is generated via a complete data word and this must then be encoded again and is appended. It is therefore not coded via the individual segments, but via the bit sequence as a whole.

The center shows another prior art example in which the line coding step of the forward error correction is omitted and non-encoded parity information is appended. The disadvantage here is that the last data part, i.e. the parity information, is not line-coded and is therefore highly error-prone.

The right-hand side shows an example which, in contrast to the example in the middle, does not loop back the parity information for serial coding. This has the same disadvantages as the example in the middle.

Data transmission solutions always place stricter requirements on freedom from errors/error tolerance, which require fine tuning between serial coding and forward error correction (FEC) as data rates continue to increase.

The current state of the art (Ethernet/DisplayPort) processes the data stream in the following sequence:
1. The input data is encoded in the first step using serial encoding (8b10b, 64b66b, 128b132b etc.). For larger encodings from 64b66b upwards, this is primarily achieved by scrambling using LFSR.
2. The serial coded stream is now additionally protected against bit errors by means of FEC (Forward Error Correction) coding. A complete FEC coding (FEC coding word) contains both the input data on a symbol basis as well as the so-called parity symbols. For these applications, the input data is passed through the FEC untouched. This means that they always correspond to the original serial code. There are now the following further procedures:
   a. The parity symbols are now also serially coded afterwards (e.g. 8b10b) in order to fulfill the requirements for serial transmission (run length, DC balance etc.). This additional subsequent coding of the parity symbols requires an additional encoder in hardware.
   b. Instead of the aforementioned subsequent serial coding of the parity symbols, there are also solutions with feedback of the parity symbols to step 1). With a serial encoder, it is possible to control the DC balance based on the selection of a positive or negative symbol. However, this is associated with a corresponding dead time (depending on the values of serial coding and the FEC encoder). This can, for example, lead to a large deviation in the amount of the temporary DC balancing.
   c. The parity symbols are sent untreated directly to the serial link (e.g. DisplayPort 2.0). However, this is very inaccurate as the parity symbols are generated depending on the input data. Here one relies on the fact that the parity symbols are DC-balanced on average.

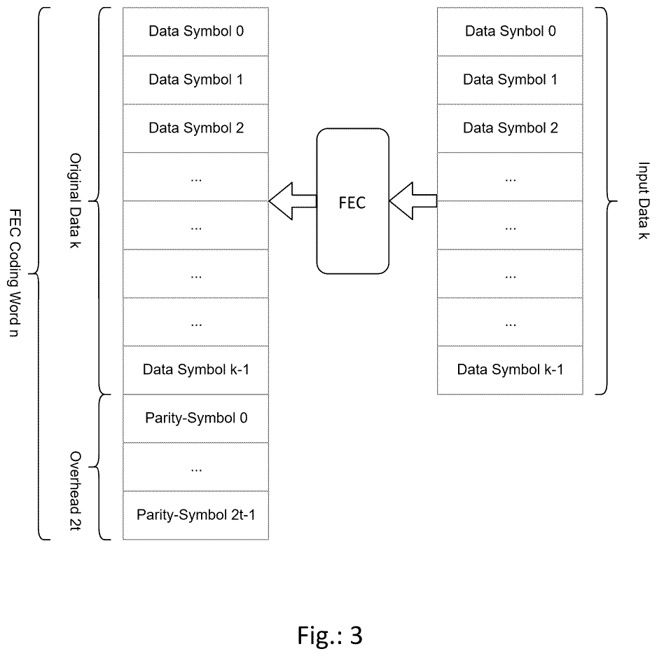

All the methods mentioned (a-c) have the disadvantage that they require a large amount of resources (e.g. two serial encoders) or lead to insufficiently accurate serial coding (e.g. DC balancing, run length, spectrum). In particular, the inaccurate control of the serial coding in combination with the transmission channel can lead to the data stream not being reconstructed correctly on the receiver side (CDR samples incorrectly). These effects are mitigated in operation with FEC (as it corrects bit/symbol errors), which unnecessarily deprives the FEC encoding of correction margin for further necessary error correction for errors caused by signal integrity or e.g. external influences with each error caused by the poor serial encoding. A Reed Solomon FEC can only correct t symbol errors based on the size of the overhead (2t see FIG. 3) in symbols.

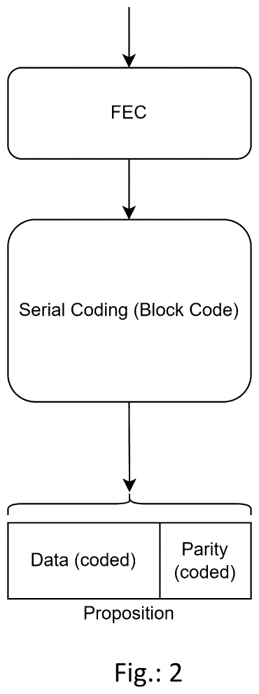

FIG. 2, on the other hand, shows the method according to embodiments of the invention, in which forward error corrections are generated via the user data and these are then also encoded with the user data. The advantage here is that both the user data and the forward error correction are line-coded and therefore errors are robust. This figure also shows that the difference to the prior art is that the forward error correction is generated directly on the user data and not on the line-coded user data. This then makes it possible to transmit all data in line-coded form, which in turn results in increased error robustness.

The method proposed below to improve the above-mentioned problems applies to all conceivable ECC/FEC encodings and is not only applicable to Reed Solomon codes.

The procedure presented changes the sequence of serial coding and FEC:
1. The input data is protected in the first step by means of FEC or several individual FEC units of smaller symbol width (6-12 bits). This also leads to an overall overhead of 2t.
   The use of several FEC sub-codings is expressly preferred here, as this has further positive properties (explained below).
2. The respective current FEC output symbol(s) (not to be confused with the entire FEC coding word n) is then coded using block code in such a way that all the desired properties of DC balance, run length, frequency spectrum etc. are maintained.
   In the case of multiple FEC coding in step 1.), exactly the same number of block coders is used here. On the receiving side, this means that a bit error on the link that destroys a complete data symbol of the serial code results in only a single FEC symbol error.

FIG. 3 shows a prior art flowchart where the input data is line coded and then a forward error correction is generated. This forward error correction is appended to the present right-hand side, as shown at the bottom. This means that the data word is first line-encoded at the top and then a non-line-encoded forward error correction is appended. This now presents a problem, as the forward error correction does not have the desired properties that are necessary for robust data transmission. This results in disadvantages because the data is not DC (digital current) balanced, i.e. an advantageous parity is not set. In addition, errors can occur during clock recovery with non-line-coded transmission. In general, line coding is advantageous in that an average value of the analog signals can be measured and then it can be checked which actual signals are above this average value and which are below it. Here it is desirable that the number of analog signals above the mean value, i.e. digital “1”, is equal to the number of analog signals below the mean value, i.e. digital “0”. This means that optimized signal modelling can be carried out. This is not possible in the present FIG. 3, as the forward error correction code is not line coded.

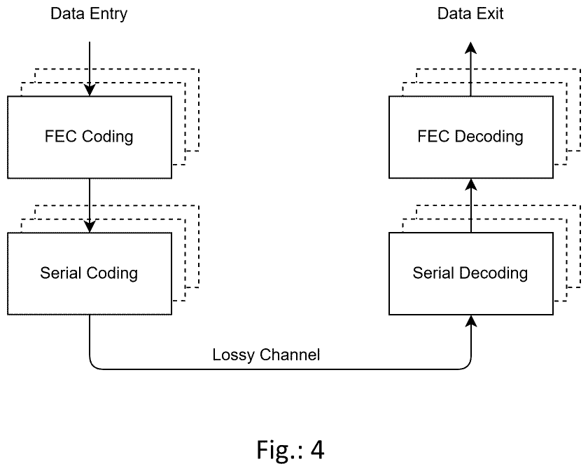

FIG. 4 shows the procedure according to embodiments of the invention and transmission via a lossy channel. Here, each channel is potentially subject to loss and it is particularly advantageous that the forward error coding takes place first at the data input and then the entire serial coding takes place. On the receiver side, the procedure is carried out in reverse and serial decoding is carried out first, whereby the forward error correction is restored in addition to the user data.

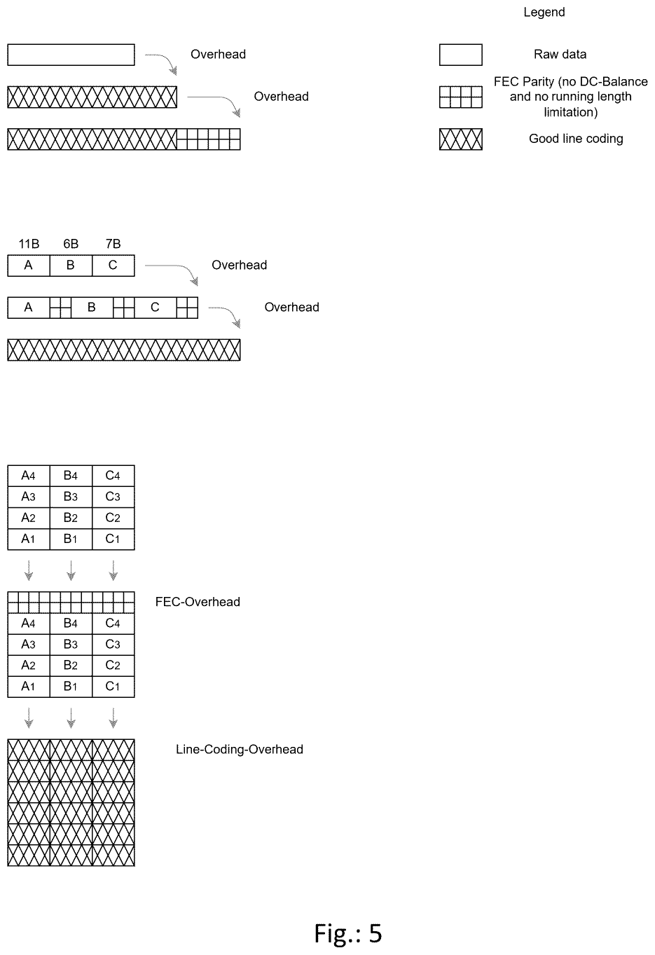

FIG. 5 shows an upper example of a prior art method in which an output data word or a bit sequence is line coded from the first to the second line in a first method step. This results in a code that is longer than the output bit sequence, which is also referred to here as overhead. In a subsequent process step, a forward error correction code is generated from the second line to the third line, which is added to the line coding. As can now be seen, the first part on the left of the data to be transmitted is line coded and the second part, namely the forward error correction, is not line coded. This causes problems, as the advantages of line coding have to be dispensed with in the appendix on the right-hand side. This is disadvantageous.

In the example in the middle of this figure, the source word ABC is again shown at the top. The bit sequence therefore consists of the segments A, B and C. These are 11 bits, 6 bits and 7 bits long. In accordance with embodiments of the invention, it is not the entire data word, i.e. the entire bit sequence, that is protected in its entirety, i.e. provided with a forward error correction code, but rather the individual segments are protected. This is shown in the second line by the fact that the corresponding forward error correction code is shown after each segment A, B and C. In a subsequent process step, line coding is applied in the third line or the data from the second line is completely line coded, resulting in a line code in the third line. This can now be transmitted and it can be seen that the entire data is line coded and that the forward error correction code is also line coded. The advantages of line coding therefore apply to all data to be transmitted.

In the embodiment example at the bottom of FIG. 5, the method steps are shown, whereby further sub-steps are possible. The different bit sequences are shown, whereby the user data has now been divided into bit sequences of the same length. Thus, the entirety of the user data is divided into four bit sequences, which are all of the same length. These four bit sequences are in turn subdivided into segments of the same length. Figuratively speaking, individual bit sequences are arranged horizontally and these bit sequences are arranged one below the other, so that each line reflects a bit sequence. As can also be seen, the bit sequences are each divided into three segments of equal length. This gives a matrix-like arrangement of the user data in bit sequences per row and segments per column.

Now a line coding is not carried out, as provided for in the prior art, but a partial forward error correction is calculated for each column, i.e. for all segments at the same bit position, in accordance with the subdivision rule as specified in the upper process step. As can be seen in the first line of the second rectangle, a partial forward error correction is shown above, which is referred to in its entirety as FEC overhead in this figure. The segmented bit sequences are now available in accordance with the subdivision rule and the partial forward error corrections are available for all segments of the same bit position across all bit sequences.

A segment encoder is now applied to all segments of the same bit position to generate segment line codes for all segments per bit position and per bit sequence. In a further or in the same process step, the segment encoder that was also used for the segments is applied to the respective partial forward error correction, resulting in a single line code comprising the segment line codes and the partial forward error correction line codes. As can now be seen below in the present FIG. 5, all data has therefore been line coded and, in particular, the forward error correction FEC has also been line coded. This means that this data can now be transmitted advantageously.

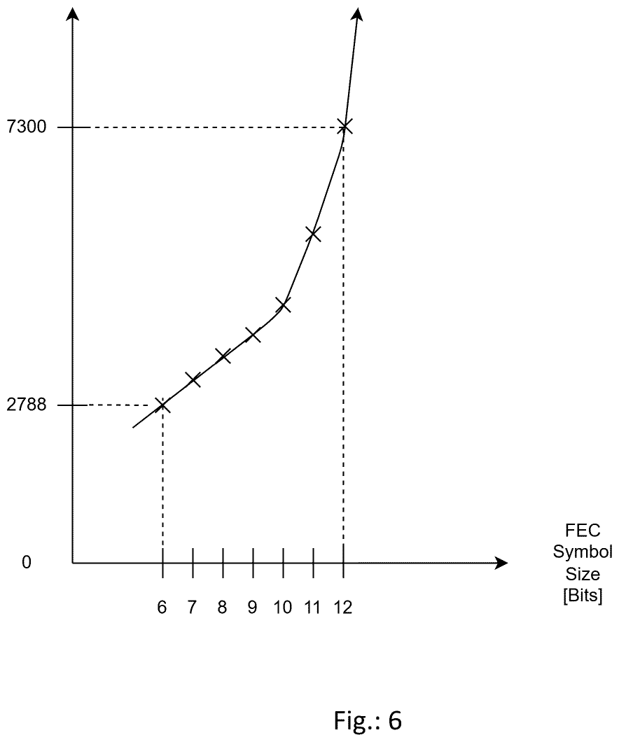

FIG. 6 shows in a diagram on the y-axis the number of gates required when creating a forward error correction code as a function of the bit length to be encoded on the x-axis. As can be seen here, this is an exponential growth and from a bit length of 10-12 bits, the growth of the gates, i.e. the number of gates required for the forward error corrections, increases at an above-average rate. It is therefore particularly advantageous to carry out the forward error correction for each segment, as this avoids having to take into account the entire data word, i.e. the entire bit length. If the entire bit length had to be taken into account for the forward error correction, the bit length would typically be beyond the critical 12 bits. The gates required in the forward error correction encoder would increase in an unfavorable manner. This therefore illustrates an advantageous technical effect of the present invention, which first forms segments via the bit sequence and then calculates the forward error correction on the segments.

At this point, reference is again made to the subdivision rule according to FIG. 5, which provides that a segment can have 11 bits, 6 bits or 7 bits.

By using several FEC encoders/decoders with a smaller FEC symbol size, both the number of required gates is reduced and the maximum operating frequency for a given process node Fₘₐₓ is increased (shorter carry chains, more parallelism).

FIG. 6 shows the relationship between the FEC symbol size in bits and the required implementation. This refers to a hardware implementation of a Reed Solomon FEC. The number of gates is normalized (to 12 bit symbol size) and can therefore be compared directly. The exponentially pronounced relationship between symbol size in bits and the implementation in gates can be seen in the graph.

The same symbol widths do not always have to be used for the respective small FEC sub-encoders. Large serial encodings can also consist of several different sub-encoders (the simplest example is 8b10b which can be constructed from 3b4b and 5b6b), as proposed for use with FEC. In the case of embodiments of the present invention or ADXpress (registered trademark), this is achieved by a total of 11 encoders with four basic types: 6b8b, 7b8b, 11b12b and 11b13b. The FEC symbol width used for the respective sub-coding is determined by the data word width of the respective serial encoder. For example, an FEC with a symbol width of 6 bits is used for 6b8b.

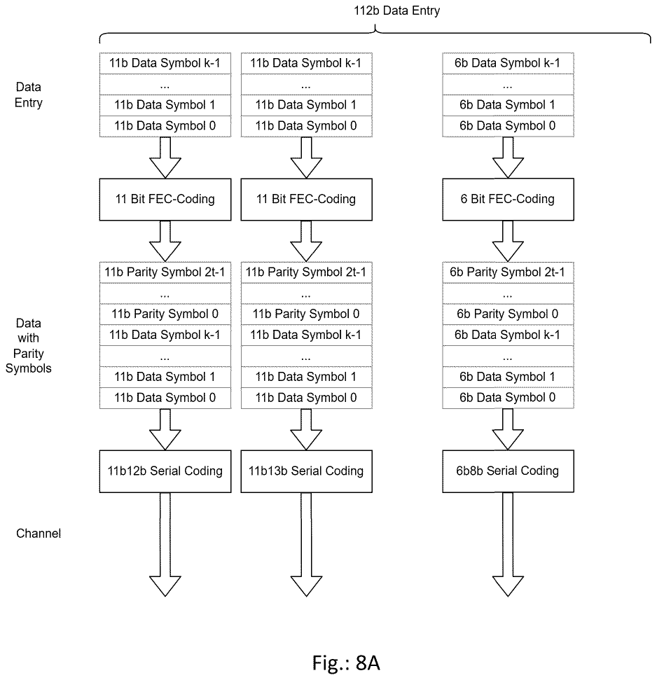

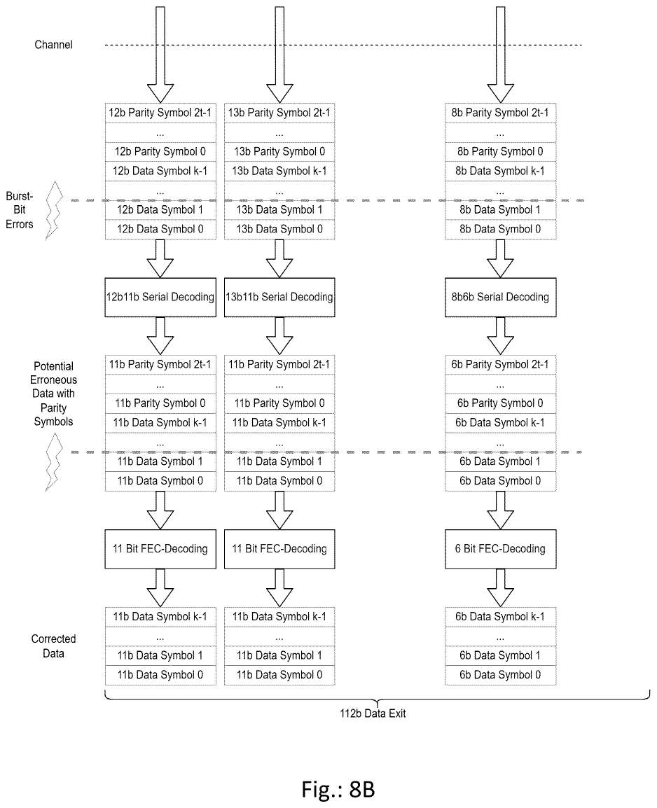

The complete structure for the transmitter data path of embodiments of the present invention or ADXpress (registered trademark) is shown according to one aspect in FIG. 8A. The data path in the receiver has a corresponding inverse structure (see also FIG. 8B).

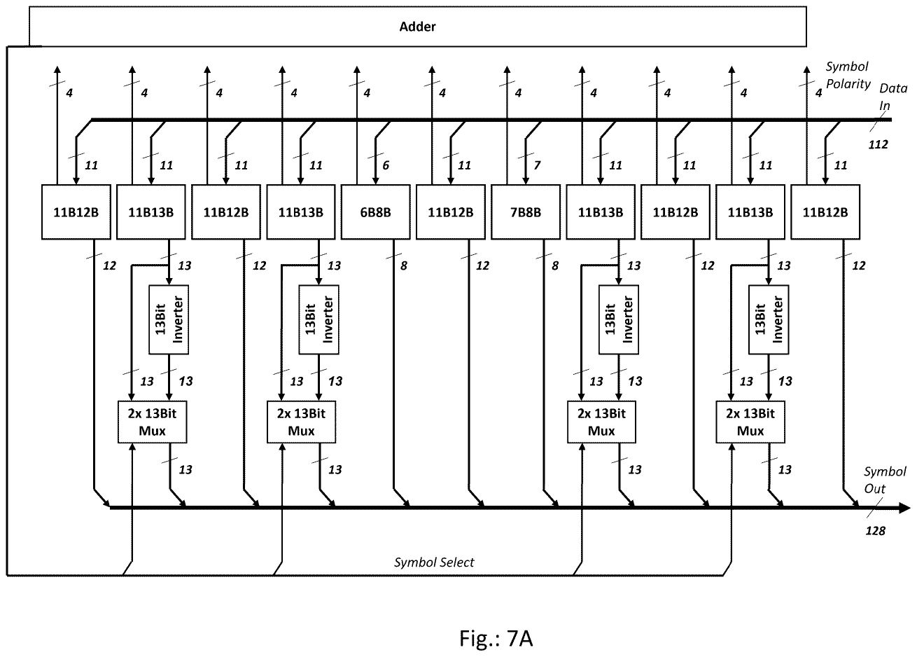

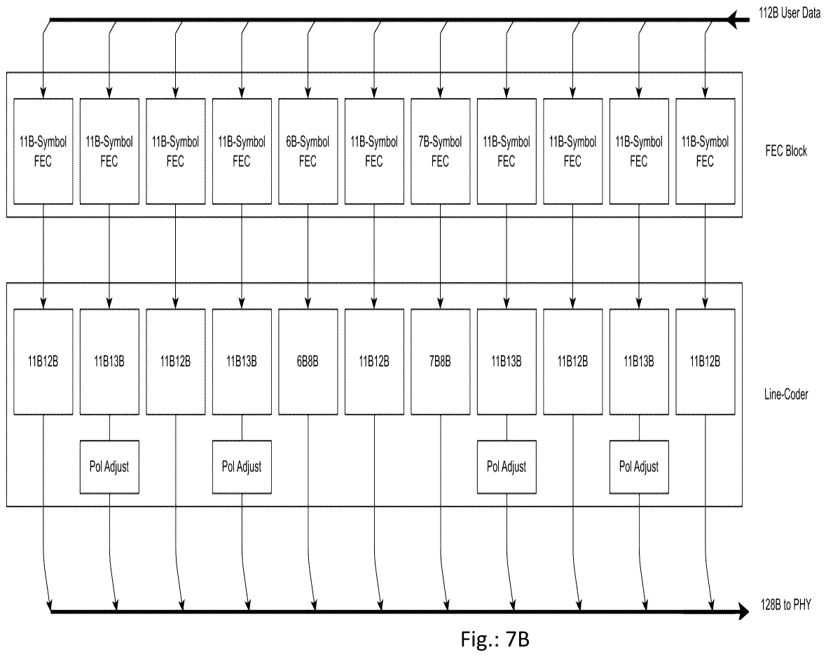

FIG. 7A shows a line coding or a line coding device with several line coding units which, for example, map 11 bits to 12 bits, map 11 bits to 13 bits, or map 11 bits to 12 bits. This corresponds to the right-to-left sequence in the present FIG. 7 and illustrates that the input data word, i.e. the bit sequence above, is divided into individual segments and then the individual segments are line coded. The calculation of the forward error correction is not yet taken into account in the present FIG. 7A, so that the system arrangement according to FIG. 7A can serve as the output system arrangement for the present invention.

FIG. 7A shows above the arbitrary bit sequence of 112 bits, which is segmented into 11, 6 or 7 bits. The coding units are then addressed in parallel, which convert the bits into sub-symbols in such a way that they are optimized in terms of disparity. For example, 11 bits are encoded after 12 bits or 11 bits after 13 bits.

In this FIG. 7A, a coding unit from of the second subset, which is labeled 11B12B, is shown on the far left in the middle. This provides a partial symbol with any sign, i.e. with any disparity. To compensate for this disparity, the coded unit 11B13B is connected downstream in parallel with respect to the bit sequence. This means that a data stream is formed which converts the most significant bits of twice 11 into two sub-symbols, namely once the 11-bit data segment is formed by 11B12B into a 12-bit sub-symbol with any sign, i.e. disparity, and once the data segment is encoded from 11 bits into 13 bits by means of the encoding unit 11B13B. In the figure below the coding units, the second coding unit from the left 11B13B is a coding unit of the first subset.

This has an inverter and a multiplexer. The first 13 bits are therefore available as a data stream, which is split in such a way that it is inverted once with regard to the sign, i.e. the disparity, and once remains unchanged. It is shown below that the positive or negative, i.e. the original or inverted data stream that compensates for the sign from the leftmost coding unit is used under disparity feedback. There are therefore two data streams at the first multiplexer on the left, each of which represents the partial symbol, one with a conventional sign, i.e. as output from the 11-bit 13-bit coding unit, and one with an inverted sign or inverted disparity.

Based on the feedback from the unit at the top, it is therefore determined which disparity results from the leftmost encoder 11B12B and thus the multiplexer, at the bottom left, compensates or minimizes the disparity of the partial symbol of the leftmost encoder 11B12B. This is carried out in parallel in such a way that the coding units from the second subset are followed by coding units from the first subset, which minimize or eliminate the disparity. Finally, the total symbol is output at the bottom right. This total symbol has 128 bits and is composed of the sub-symbols as they are inserted into the bold line below using the slanted arrows. Thus, the sub-symbols which are optimized or minimized with regard to disparity are present on this output line and these sub-symbols form the entire symbol which can then be output and transmitted.

According to one aspect of the present invention, the invention encodes a 112-bit wide data word, with any disparity (disparity max: 112) and any run length (run length max: 112), onto a 128-bit wide symbol. This means that the overhead resulting from the coding is 14.2%.

The maximum run length occurring in the symbol, as well as with any sequencing of any symbols, is 8 equal bits.

The maximum disparity in the long average is 0 and the disparity in a symbol is less than 9.

The complexity of the logic is minimal, comparable to 10 8B/10B encoders (with the known disadvantage of the large overhead).

This is achieved by the use, or parallel use, of several “small” encoders that are optimally matched to each other in terms of their disparity and run length characteristics.

The encoders 11B12B, 7B8B and 6B8B generate all symbols with a guaranteed maximum run length of 6, even if the (partial) symbols are sequenced in any order.

According to one aspect of the present invention, the encoder (11B13B) generates symbols with a guaranteed maximum run length of 7 or at the beginning or end of the symbol of 5. Due to the sequencing (FIG. 2) of (11B13B) with the other encoders, a maximum run length of 8 can thus be generated in the symbol.

See properties of the encoder as follows:
11B13B: 11 bits of data are mapped to 2048 symbols with 13 bits. The symbols can be transmitted in inverted or non-inverted form.
   Disparity:
   +3 . . . +9 or controllable −3 . . . −9
   Run length in the word: 7
   Run length at the edge: 5.
11B13B: 11-bit data is mapped to 2048 symbols with 13 bits. The symbols can be transmitted in inverted or non-inverted form.
   Disparity: +3 . . . +9 or controllable −3 . . . −9
   Run length in the word: 7
   Run length at the edge: 5
11B12B: 11-data is mapped to 2048 symbols with 12 bits. The symbols are only transmitted non-inverted.
   Disparity: −2, −1, 0, 1, 2
   Run length in the word: 6
   Run length at the edge: 3
7B8B: 7-bit data is mapped to 128 symbols with 8 bits. The symbols are only transmitted non-inverted.
   Disparity: −2, −1, 0, 1, 2
   Run length in the word: 6
   Run length at the edge: 3
6B8B: 6-bit data is mapped to 64 symbols with 8 bits. The symbols are only transmitted non-inverted.
   Disparity: 0
   Run length in the word: 6
   Run length at the edge: 3

With the four 11B13B encoders, a disparity of at least +−12 can be controllably generated in order to compensate for the non-controllable disparity of a maximum of +−12 (6×+−2) of the 11B12B and 7B8B encoders, so that a balanced disparity can be reliably achieved irrespective of the data to be transmitted.

In order to further reduce the complexity of the hardware, four small encoders (11B13B) are used according to one aspect of the present invention, the disparity of which can be controlled with regard to sign (+−).

According to one aspect of the present invention, the symbol disparity is controlled in such a way that each encoder calculates the parity of “its” sub-symbol. This is done with little effort, since the subsymbol has only a few bits.

With four of the eleven encoders, the sign of the disparity of the sub-symbol can be actively controlled by inverting the generated sub-symbol. For this purpose, the encoders (11B13B) have the special feature that their symbols generate a symbol with positive disparity (+3 . . . +9) for all input data. By inverting the partial symbol, a symbol with negative disparity (−3 . . . −9) is obtained.

In this way, the disparity (−2,−1,0,1,2) of the partial symbols of the other encoders (11B12B and 7B8B) can be compensated. The encoder 6B8B generates symbols whose disparity is always 0. Then all (partial) parities of the encoders (11B12B and 7B8B) are added together and the result controls the decision as to how many inverted and non-inverted symbols of the encoder (11B13B) are used.

The minimum (smallest) disparity of the encoder 11B13B is +−3. So in total, a disparity of +−12 (4*+−3) per symbol can be safely compensated with these four encoders.

Furthermore, five (11B12B) encoders and one (7B8B) encoder are used whose maximum disparity is +−2. So in the extreme case, these six encoders generate a disparity of exactly +−12 (2*+−6). This can be safely compensated by the 11B13B encoders.

According to one aspect of the present invention, the method achieves the same quality as an 8B10B code but with half the overhead (loss due to encoding).

The implementation of the encoding and decoding hardware requires minimal resources (logic) due to the use of multiple small encoders instead of one large one.

Encoding can typically be done completely in one cycle of the parallel data path (no pipelining necessary).

The control of the disparity of the 128 bit symbol can be realized with (very) little logic, and can be realized completely within one clock cycle of the data path (slow), instead of calculating the disparity by counting the one and zero bits in the serial data stream with the very fast serial clock.

Due to the deterministic disparity and run length, further scrambling is not necessary and therefore fast synchronization to the data stream is possible on the receiver side (no scrambler synchronization necessary).

Among other things, this is very useful for power save modes in which the link can be switched off to save energy and switched on again when required. For this, fast synchronization between transmitter and receiver is a must.

According to one aspect of the present invention, the invention encodes a 112-bit wide data word, with any disparity (disparity max: 112) and any run length (run length max: 112), onto a 128-bit wide symbol. The overhead resulting from the coding is therefore 14.2%.

The maximum run length occurring in the symbol, as well as with any sequencing of any symbols, is 8 equal bits.

The maximum disparity in the long average is 0 and the disparity in a symbol is less than 9.

The complexity of the logic is minimal, comparable with 10 8B/10B encoders (with the known disadvantage of the large overhead).

This is achieved by the use, or parallel use, of several “small” encoders that are optimally matched to each other in terms of their disparity and run length characteristics.

The encoders 11B12B, 7B8B and 6B8B generate all symbols with a guaranteed maximum run length of 6, even if the (partial) symbols are sequenced in any order.

According to one aspect of the present invention, the encoder (11B13B) generates symbols with a guaranteed maximum run length of 7 or at the beginning or end of the symbol of 5. Due to the sequencing (FIG. 2) of (11B13B) with the other encoders, a maximum run length of 8 can thus be generated in the symbol.

See properties of the encoder as follows:

To further reduce the complexity of the hardware, four small encoders (11B13B) are used whose disparity can be controlled in terms of sign (+−).

According to one aspect of the present invention, the symbol disparity is controlled in such a way that each encoder calculates the parity of “its” sub-symbol. This is done with little effort, since the subsymbol has only a few bits.

With four of the eleven encoders, the sign of the disparity of the subsymbol can be actively controlled by inverting the generated subsymbol. For this purpose, the encoders (11B13B) have the special feature that their symbols generate a symbol with positive disparity (+3 . . . +9) for all input data. By inverting the partial symbol, a symbol with negative disparity (−3 . . . −9) is obtained.

In this way, the disparity (−2,−1,0,1,2) of the partial symbols of the other encoders (11B12B and 7B8B) can be compensated. The encoder 6B8B generates symbols whose disparity is always 0. Then all (partial) parities of the encoders (11B12B and 7B8B) are added together and the result controls the decision as to how many inverted and non-inverted symbols of the encoder (11B13B) are used.

The minimum (smallest) disparity of the encoder 11B13B is +−3. So in total, a disparity of +−12 (4*+−3) per symbol can be safely compensated with these four encoders.

Furthermore, five (11B12B) encoders and one (7B8B) encoder are used whose maximum disparity is +−2. So in the extreme case, these six encoders generate a disparity of exactly +−12 (2*+−6). This can be safely compensated by the 11B13B encoders.

The process achieves the same quality as an 8B10B code but with half the overhead (loss due to coding).

The implementation of the encoding and decoding hardware requires minimal resources (logic) due to the use of multiple small encoders instead of one large one.

Encoding can typically be done completely in one cycle of the parallel data path (no pipelining necessary).

The control of the disparity of the 128 bit symbol can be realized with (very) little logic, and can be realized completely within one clock cycle of the data path (slow), instead of calculating the disparity by counting the one and zero bits in the serial data stream with the very fast serial clock.

Due to the deterministic disparity and run length, further scrambling is not necessary and therefore fast synchronization to the data stream is possible on the receiver side (no scrambler synchronization required).

Among other things, this is very useful for power save modes in which the link can be switched off to save energy and switched on again when required. For this, fast synchronization between transmitter and receiver is a must.

FIG. 7B now shows the adapted system arrangement from FIG. 7A, with the corresponding partial forward error correction encoders now drawn in. These are referred to here as FEC blocks. This figure therefore shows that segments are first formed from the bit sequences, which corresponds to the upper arrows pointing downwards from the user data. This is where the partial forward error corrections are generated and then fed into the coding units, as already shown in FIG. 7A. The line coding units are referred to here as line coders and encode both the segments of the bit sequences and the partial forward error corrections. The parity can also be adjusted in optional process steps. The line-coded data is then output at the bottom and transmitted to the right via a potentially faulty communication channel to a receiver, not shown here.

FIG. 8A shows a method according to the invention for improving the forward error correction and shows in particular the method steps which are carried out on the transmitter side. The arrows at the bottom of this FIG. 8A correspond to the arrow at the top of the following FIG. 8B. The data is therefore entered as shown in FIG. 8A and then the partial forward error correction is calculated. As can be seen above, all segments are of the same bit length. This means that the first column comprises 11 bits, the second column comprises 11 bits and the last column comprises 6 bits.

A partial forward error correction is now generated for all segments of the same bit sequence, which has the same bit length as the corresponding segments. This results in the data with a parity symbol. In a final process step, the serial line coding takes place, which for example maps 11 bits to 12 bits or maps 11 bits to 13 bits or maps 6 bits to 8 bits. This data can now be transmitted via the potentially interference-prone channel. This results in a transmission as shown in FIG. 8A below or in FIG. 8B above.

FIG. 8B shows the procedure on the receiver side and corresponds inversely to the procedure in FIG. 8A. As also shown in the present FIG. 8B, it is recognized that bit errors may be present, but these can be handled particularly advantageously at segment level. The bit errors therefore do not occur in the entire bit sequence, but only on individual segments and can therefore be treated advantageously. This leads to the corrected data as shown in FIG. 8B below and the 112 bits are thus recovered as they were used as the output in FIG. 8A.

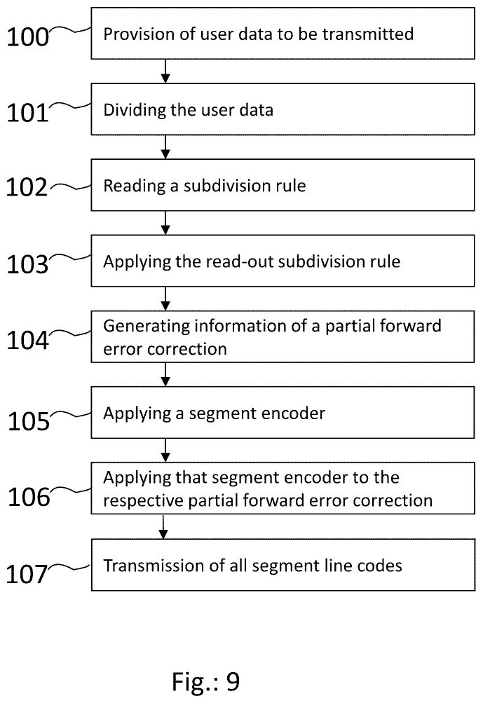

FIG. 9 shows in a flow chart a method for improving the forward error correction in serial coding in a data transmission in the vehicle, comprising a provision 100 of user data to be transmitted; a division 101 of the provided user data into a plurality of bit sequences of the same length in each case; reading out 102 a subdivision rule which subdivides a bit sequence into a sequence of segments each of predefined length at a predefined bit position; applying 103 the read-out subdivision rule to all bit sequences of the plurality of bit sequences; iteratively creating 104 in each case a partial forward error correction for all segments of the same bit position over all bit sequences; an iterative 105 application in each case of a segment encoder over in each case all segments of the same bit position for generating segment routing codes over all segments per bit position and per bit sequence; an application 106 in each case of that segment encoder to the respective partial forward error correction which was also applied 105 for the segments with respect to which the respective partial forward error correction was created 104 for generating in each case one partial forward error correction routing code per partial forward error correction; and a transmission 107 of all segment routing codes and all partial forward error correction routing codes.

All segment line codes and all partial forward error correction line codes are also transferred: In this last step, all generated segment guidance codes and partial forward error correction guidance codes are transmitted. These transmitted codes contain the information for error detection and correction for the corresponding segments and partial forward error corrections. The method described at enables improved forward error correction during serial coding and data transmission in the vehicle. By dividing the user data into segments and applying specific coding procedures to these segments, effective error detection and correction is achieved at segment level.

By iteratively creating a partial forward error correction for all segments of the same bit position and applying a segment encoder to each segment, targeted error correction for the transmitted data is made possible. The partial forward error correction line codes contain the necessary information to detect and correct errors, while the segment line codes represent the structure and content of the segments and also contribute to error detection and correction.

By transmitting all the generated segment line codes and partial forward error correction line codes, the receiver can analyze the received data accordingly and detect and correct errors to ensure reliable and accurate transmission of the user data in the vehicle.

The method described thus provides improved forward error correction, which is particularly important in challenging environments such as vehicles where interference and signal loss can occur. It helps to ensure reliable and high-quality data transmission, which is of great importance for various applications in the vehicle sector, such as autonomous driving, vehicle safety systems and infotainment applications.

Embodiments of the invention make it possible to maintain all the desired characteristics and requirements for serial coding at all times while operating an FEC efficiently. By deliberately positioning the serial encoder after the FEC units, the physical behavior on the link is always deterministically controllable (not the case with scrambler as serial encoding).

In addition, the selection of the FEC symbol size based on the data word size of the respective serial sub-encoder always ensures that bit errors always propagate to a minimum (a defective line code symbol then only generates a defective FEC symbol).

Furthermore, the use of several FEC sub-encoders creates a very efficient type of so-called interleaving. This is possible without time-consuming manual interleaving of the symbols, which would always require data to be held (more latency and buffer). This also makes it possible to correct burst errors, e.g. 112/128 bit errors at once.

It can only be seen from the schematic structure in FIGS. 7A, 7B and 8A, 8B that this is the case: in this case, 128 bit errors lead to only one single symbol error of the respective FEC sub-encoder. With classic single FEC coding, a burst error of the same length (128 erroneous bits in succession) would generate several symbol errors in succession. Depending on the encoding selected, this can lead to the FEC word (all symbols of an FEC cycle) no longer being able to be decoded (which also makes correction impossible). This is normally achieved by interleaving the symbols of an FEC cycle with those of one or more other FEC cycles. However, this is only possible by using buffers on the transmitter and receiver side in order to be able to interleave the data in the case of the transmitter and to bring this back into the original continuous FEC symbol data stream of the individual FEC cycles in the receiver by means of the inverse operation. By using several small FEC encoders, interleaving and thus also the provision of the buffers required for interleaving becomes superfluous (but only to a certain extent; a burst error of more than the 128 bits in succession mentioned in the example leads to more than one symbol being damaged per individual FEC).

How many symbols a respective FEC sub-encoder can repair (t) depends on the overhead 2t see FIG. 2. This must be selected accordingly for the desired application. The case shown in FIG. 8A with one symbol error per FEC sub-encoder is already reached at t=1 (i.e. two parity symbols overhead). It should also be noted that the burst error may/can also occur without any restrictions in the area of the parity symbols.

What is claimed is:

1. A method for improving forward error correction in serial line coding in an in-vehicle data transmission, comprising:
a provision (100) of user data to be transmitted;
dividing (101) the user data provided into a plurality of bit sequences of the same length in each case;
reading (102) a subdivision rule from a hardware architecture, wherein the subdivision rule is not stored in a data memory, which subdivides a bit sequence into a sequence of segments each of predefined length at a predefined bit position, such that different encoders are provided for different bit lengths and the corresponding segments correspond to the respective encoders;
applying (103) the read-out subdivision rule to all bit sequences of the plurality of bit sequences;
generating (104) in each case information of a partial forward error correction for all segments of the same bit position over all bit sequences;
applying (105) in each case a segment encoder over in each case all segments of the same bit position for generating segment line codes over all segments per bit position and per bit sequence;
applying (106) in each case that segment encoder to the respective partial forward error correction which was also applied (105) to the segments with respect to which the respective partial forward error correction information was generated (104) in order to generate in each case one partial forward error correction guide code per partial forward error correction; and
a transmission (107) of all segment line codes and all partial forward error correction line codes.

2. The method of claim 1, wherein all bit sequences are structured identically in their data format, have the same segment lengths and/or the same bit positions.

3. The method of claim 1, wherein the information for partial forward error correction has correction information which describes a nominal content of the segment over which the information for partial forward error correction was created.

4. The method of claim 1, wherein the information for partial forward error correction has the same bit length as the segment over which it is created.

5. The method of claim 1, wherein a totality of the partial forward error corrections describes all user data to be transmitted in a correctable manner.

6. The method of claim 1, wherein the segment coders each generate at least a part of a line code.

7. The method of claim 1, wherein the totality of the segment encoders encodes bit sequences of 112 bits into words of 128 bits.

8. The method of claim 1, wherein the partial forward error correction line codes are appended to the segment line codes during transmission (107).

9. The method of claim 1, wherein the bit position is specified as an offset or as a bit index in the bit sequence.

10. The method of claim 1, wherein the user data is present as a serial data stream.

11. The method of claim 1, wherein the method steps are executed in the sequence described and/or are executed iteratively.

12. A system arrangement for improving the forward error correction in serial line
coding in a data transmission in the vehicle, comprising an interface unit set up to provide (100) user data to be transmitted;
a splitting unit set up for splitting (101) the user data provided into a plurality of bit sequences of the same length in each case;
a further interface unit set up for reading (102) a subdivision rule from a hardware architecture, wherein the subdivision rule is not stored in a data memory, which subdivides a bit sequence into a sequence of segments each of predefined length at a predefined bit position, in such a way that different encoders are provided for different bit lengths and the corresponding segments correspond to the respective encoders;
a subdivision unit arranged to apply (103) the read-out subdivision rule to all bit sequences of the plurality of bit sequences;
a correction unit arranged to generate (104) in each case information for partial forward error correction for all segments of the same bit position over all bit sequences;
an encoder unit set up for (105) applying a segment encoder in each case over all segments of the same bit position for generating segment line codes over all segments per bit position and per bit sequence;
a further coding unit arranged to apply (106) to the respective partial forward error correction the respective segment coder which was also applied (105) to the segments with respect to which the respective partial forward error correction was created (104) in order to generate a respective partial forward error correction guide code for each partial forward error correction; and
a transmission unit adapted to transmit (107) all segment line codes and all partial forward error correction line codes.

13. A computer program product comprising instructions fixed in a non-transitory medium which, when the program is executed by at least one computer, cause the computer to perform the steps of the method of claim 1.

14. A non-transitory computer readable storage medium comprising instructions which, when executed by at least one computer, cause the computer to perform the steps of the method of claim 1.
